(19) United States
(12) Patent Application Publication
(10) Pub. No.: US 2026/0283413 A1
(43) Pub. Date: Sep. 24, 2026

(54) TOWEL HEATING DEVICE

(71) Applicant: Guangzhou Hansong Tuojiang Technology Co., Ltd., Guangzhou (CN)

(72) Inventors: Zhenji Lin, Guangzhou (CN); Yueqing Li, Guangzhou (CN)

(21) Appl. No.: 19/670,103

(22) Filed: May 7, 2026

Related U.S. Application Data
(63) Continuation-in-part of application No. 19/339,361, filed on Sep. 25, 2025, now Pat. No. 12,685,412.
Application No. 19/339,361 is a continuation-in-part of application No. 19/189,293, filed on Apr. 25, 2025, now Pat. No. 12,672,742.
Application No. 19/189,293 is a continuation-in-part of application No. 18/763,632, filed on Jul. 3, 2024, now Pat. No. 12,329,326.
Application No. 18/763,632 is a continuation-in-part of application No. 18/763,734, filed on Jul. 3, 2024, now Pat. No. 12,507,836.
Application No. 19/339,361 is a continuation-in-part of application No. 19/216,795, filed on May 23, 2025, now Pat. No. 12,490,871.
Application No. 19/216,795 is a continuation-in-part of application No. 18/763,632, filed on Jul. 3, 2024, now Pat. No. 12,329,326.
Application No. 18/763,632 is a continuation-in-part of application No. 18/763,734, filed on Jul. 3, 2024, now Pat. No. 12,507,836.
Application No. 19/339,361 is a continuation-in-part of application No. 19/216,853, filed on May 23, 2025, now Pat. No. 12,557,946.
Application No. 19/216,853 is a continuation-in-part of application No. 18/763,632, filed on Jul. 3, 2024, now Pat. No. 12,329,326.
Application No. 18/763,632 is a continuation-in-part of application No. 18/763,734, filed on Jul. 3, 2024, now Pat. No. 12,507,836.
Application No. 19/339,361 is a continuation-in-part of application No. 30/007,620, filed on Jun. 10, 2025.

(30) Foreign Application Priority Data
Mar. 7, 2024 (CN) 202410260988.9
Mar. 7, 2024 (CN) 202420441375.0
Apr. 8, 2025 (CN) 202520656668.5
Apr. 25, 2025 (CN) 202520812659.0
Apr. 25, 2025 (CN) 202520812692.3
May 28, 2025 (CN) 202530301692.2
Jun. 23, 2025 (CN) 202521300693.6

(51) Int. Cl. A47K 10/06

(52) U.S. Cl. CPC A47K 10/06

(57) ABSTRACT

A towel heating device includes: a foldable bracket, a device body, and a heating assembly. The foldable bracket includes a first support and a second support rotatably connected thereto. The device body includes a body portion, a first installation portion and a second installation portion. The first and the second installation portions are formed on two sides of the body portion. At least part of the body portion is flexible, and the body portion is foldable or expandable; a heating chamber is formed inside the body portion; the first installation portion is adaptively connected to the first support, the second installation portion is adaptively connected to the second support. The heating assembly is arranged inside the body portion and configured to heat the heating chamber. The first support and the second support are capable of moving with respect to each other to unfold or fold the body portion.

### CROSS REFERENCE TO RELATED APPLICATIONS

This application is a continuation-in-part application of the U.S. patent application Ser. No. 19/339,361, filed on Sep. 25, 2025. The U.S. patent application Ser. No. 19/339,361 is a continuation-in-part application of: the U.S. patent application Ser. No. 19/189,293, filed on Apr. 25, 2025; the U.S. patent application Ser. No. 19/216,795, filed on May 23, 2025; the U.S. patent application Ser. No. 19/216,853, filed on May 23, 2025; and the US design No. Ser. No. 30/007,620, filed on Jun. 10, 2025. The U.S. patent application Ser. No. 19/189,293 is a continuation-in-part application of: the U.S. patent application Ser. No. 18/763,632, filed on Jul. 3, 2024 (which has the U.S. Pat. No. 12,329,326); and the U.S. patent application Ser. No. 18/763,734, filed on Jul. 3, 2024. The U.S. patent application Ser. No. 19/216,795 is a continuation-in-part application of: the U.S. patent application Ser. No. 18/763,632, filed on Jul. 3, 2024 (which has the U.S. Pat. No. 12,329,326); and the U.S. patent application Ser. No. 18/763,734, filed on Jul. 3, 2024. The U.S. patent application Ser. No. 19/216,853 is a continuation-in-part application of: the U.S. patent application Ser. No. 18/763,632, filed on Jul. 3, 2024 (which has the U.S. Pat. No. 12,329,326); and the U.S. patent application Ser. No. 18/763,734, filed on Jul. 3, 2024. The U.S. patent application Ser. No. 19/339,361 claims priorities of: the Chinese patent application No. 202410260988.9, filed on Mar. 7, 2024; the Chinese patent application No. 202420441375.0, filed on Mar. 7, 2024; the Chinese patent application No. 202520656668.5, filed on Apr. 8, 2025; the Chinese patent application No. 202520812659.0, filed on Apr. 25, 2025; the Chinese patent application No. 202520812692.3, filed on Apr. 25, 2025; the Chinese patent application No. 202521300693.6, filed on Jun. 23, 2025; and the Chinese Design No. 202530301692.2, filed on May 28, 2025. The disclosure of which is hereby incorporated by reference in their entireties.

### FIELD OF THE DISCLOSURE

The present disclosure relates to the field of household articles, and particularly to a towel heating device.

### BACKGROUND

A towel heating device may be substantially configured to receive and heat towels. The towel heating device may quickly heat the towels to an appropriate temperature, allowing a user to feel a more pleasant water temperature when taking a bath or washing a face. For the towel heating device in the art, a housing thereof may be configured as a fixed structure, occupying a large space, and may not be deformed, such that the towel heating device may not be transported and stored conveniently.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a towel heating device may be provided and may include: a foldable bracket, a device body, and a heating assembly. The foldable bracket may include a first support and a second support rotatably connected to the first support. The device body may include a body portion, a first installation portion and a second installation portion. The first installation portion and the second installation portion are formed respectively on two sides of the body portion. At least part of the body portion is flexible, and the body portion is capable of being folded or unfolded; a heating chamber is formed inside the body portion; the first installation portion is adaptively connected to the first support, the second installation portion is adaptively connected to the second support. The heating assembly is arranged inside the body portion and configured to heat the heating chamber. The first support and the second support are capable of moving with respect to each other to unfold or fold the body portion.

### BRIEF DESCRIPTION OF THE DRAWINGS

Illustrative embodiments of the present disclosure are described in detail below with reference to the attached drawing figures.

FIG. 1 is a structural schematic view of an entire towel heating device according to an embodiment of the present disclosure.

FIG. 2 is a structural schematic view of a foldable bracket according to embodiment of the present disclosure.

FIG. 3 is a structural schematic view of a device body according to an embodiment of the present disclosure.

FIG. 4 is a structural schematic view of a top cover according to an embodiment of the present disclosure.

FIG. 5 is a structural schematic view of the entire towel heating device according to another embodiment of the present disclosure.

FIG. 6 is a structural schematic view of the foldable bracket according to the another embodiment of the present disclosure.

FIG. 7 is a structural schematic view of the device body according to the another embodiment of the present disclosure.

FIG. 8 is a structural schematic view of connection between the top cover and the device body according to another embodiment of the present disclosure.

Reference numerals in the drawings:
1—foldable bracket; 11—first support; 12—second support; 111—first rotation rod; 112—first installation rod; 113—first bearing rod; 121—second rotation rod; 122—second installation rod; 123—second bearing rod;
2—device body; 21—body portion; 22—first installation portion; 23—second installation portion; 24—top cover; 210—heating chamber; 211—rigid portion; 212—flexible portion; 221—first end of first installation portion; 222—second end of first installation portion; 220—first passing space; 231—first end of second installation portion; 232—second end of second installation portion; 230—second passing space; 241—first end of top cover; 242—second end of top cover; 243—connection portion; 2101—outer shell; 2102—inner liner;
3—heating assembly.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

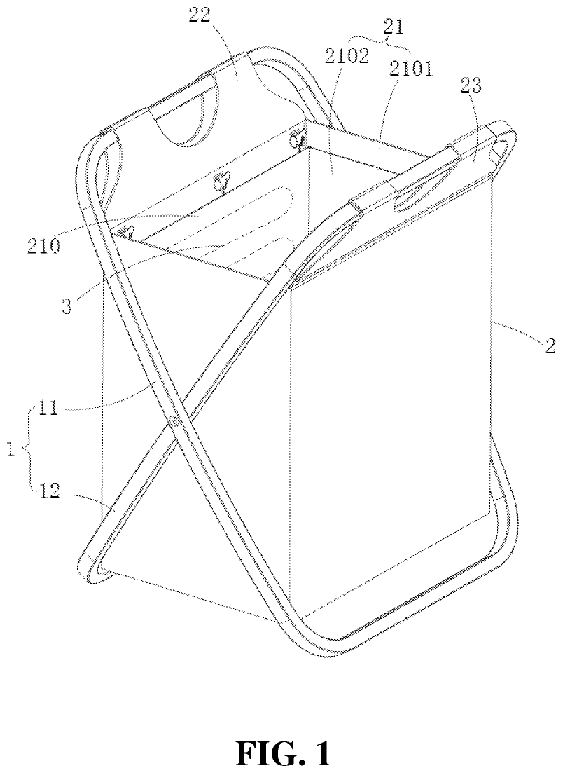

As shown in FIGS. 1 to 8, the present disclosure may provide a towel heating device, including a foldable bracket 1, a device body 2, and a heating assembly 3.

The foldable bracket 1 may include a first support 11 and a second support 12 rotatably connected to the first support 11. Relative rotation of the first support 11 and the second support 12 may achieve the foldable bracket 1 being unfolded or folded. The device body 2 may include a body portion 21, a first installation portion 22, and a second installation portion 23. The first installation portion 22 and the second installation portion 23 may be respectively formed on two sides of the body portion 21. At least part of the body portion 21 may be flexible, such that the body portion 21 is capable of being folded or unfolded. A heating chamber 210 may be formed inside the body portion 21. The first installation portion 22 may be adaptively connected to the first support 11, and the second installation portion 23 may be adaptively connected to the second support 12. Therefore, when the first support 11 and the second support 12 move with respect to each other, the first support 11 and the second support 12 may drive, via the first installation portion 22 and the second installation portion 23, the body portion 21 to be unfolded or folded.

The heating assembly 3 may be arranged inside the body portion 21 and may be configured to heat the heating chamber 210. The heating assembly 3 may be heating wires, a heating plate, or any other element that is distributed inside the body portion 21 to meet basic usage requirements of the towel heating device.

Specifically, the foldable bracket 1 may be a skeleton and a driver part of movements of the entire device. The foldable bracket 1 may be formed by the first support 11 and the second support 12 being rotatably connected to each other via a hinge or a rotation shaft. The rotatable connection may be a pivot of a folding action. When the first support 11 and the second support 12 are rotated in a first direction, the entire foldable bracket 1 may be folded, and a size thereof may be reduced. When the first support 11 and the second support 12 are rotated in a second direction reversed to the first direction, the foldable bracket 1 may be unfolded to form a stable supporting frame. The first support 11 and the second support 12 may be made of metal rods or high-strength plastic, so as to provide sufficient structural strength to bear the body portion 21 and items received therein.

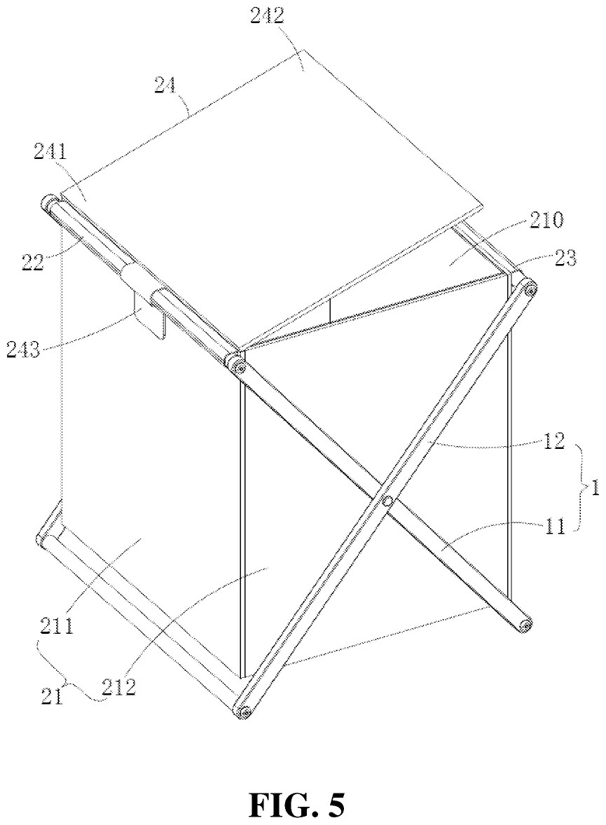

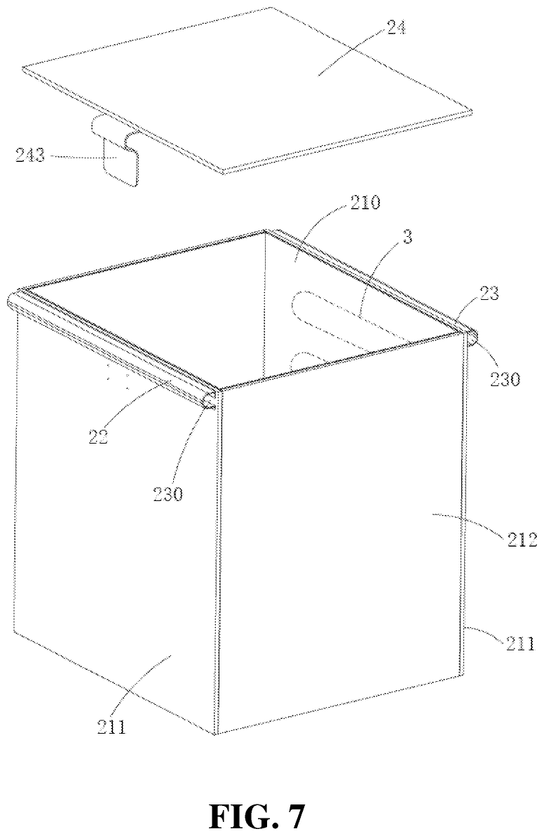

Furthermore, in order to enable the device body 2 to be folded along with the foldable bracket, at least part of the body portion 21 may be made of flexible material. For example, in some embodiments shown in FIGS. 5 and 7, the body portion 21 may include two rigid parts 211 and a flexible part 212 connected with the two rigid parts 211, such that the two rigid parts 211 may be moved toward or away from each other, and the body portion 21 may be folded or unfolded. Each of the two rigid parts 211 may be formed by filling a rigid plate, insulating cotton, and so on into cloth. The rigid plate may be a plastic plate, a wooden plate, or other materials. The rigid plate may support a shape of the rigid part 211. The flexible part 212 may be made of only cloth or made of cloth with insulating cotton filled therein.

For example, in some embodiments, such as FIG. 1, the entire body portion 21 may be flexible. In this case, the body portion 21 may be entirely made of cloth filled with insulating cotton, and any part of the body portion 21 may be flexible and capable of being reshaped.

In the above embodiments, the body portion 21 may be compressed or expanded like a cloth bag. On the two sides of the body portion 21, the first installation portion 22 and the second installation portion 23 may be integrally formed or fixedly connected to the body portion 21. Each of the first installation portion 22 and the second installation portion 23 may serve as a transmission structure between the body portion 21 and the foldable bracket 1. The first installation portion 22 may be adaptively connected to the first support 11, and the second installation portion 23 may be adaptively connected to the second support 12. The connection may be sleeving connection, snap-fitting connection, insertion connection, or any other connection manner. The first installation portion 22 and the second installation portion 23 may reliably transmit a rigid mechanical movement (relative rotation of the first support 11 and the second support 12) of the foldable bracket 1 to the flexible body portion 21, forcing the body portion 21 to perform a shape change following the movement of the foldable bracket.

Therefore, when a user needs to store the towel heating device, the user may apply an external force to rotate the first support 11 and the second support 12 in the first direction to enable the first installation portion 22 and the second installation portion 23 to move toward each other. Movement of the first support 11 and the second support 12 may drive, via the first installation portion 22 and the second installation portion 23, the two sides of the body portion 21 to move toward a middle thereof. The body portion 21 may be naturally creased or bent under the driving force, such that the entire body portion 21 may be folded, and an occupied space may be greatly reduced. Conversely, the user may apply an external force to rotate the first support 11 and the second support 12 in the second direction to drive the first installation portion 22 and the second installation portion 23 to move away from each other, enabling the body portion 21 to be restored to a regular shape.

According to the towel heating device of the present disclosure, the foldable bracket 1 may be arranged to drive the entire body portion 21, which may be flexible or partially flexible, to be folded or unfolded, such that a technical problem of a traditional towel heating device, having a fixed shape, occupying a large space, and being transported and stored inconveniently, may be solved.

In regard to a structure of the foldable bracket 1, in some embodiments, as shown in FIGS. 1, 2, 5, and 6, the first support 11 may include two first rotation rods 111 that are opposite to each other and a first installation rod 112 connected to the two first rotation rods 111. The two first rotation rods 111 may be mirror-symmetrical to each other. The first installation portion 22 may be sleeved on the first installation rod 112. Similarly, the second support 12 may include two second rotation rods 121 that are opposite to each other and a second installation rod 122 connected to the two second rotation rods 121. The two second rotation rods 121 may be mirror-symmetrical to each other. The two second rotation rods 121 may be respectively rotatably connected to the two first rotation rods 111. The second installation portion 23 may be sleeved on the second installation rod 122.

The first installation rod 112 may be connected to the two first rotation rods 111 in a lateral direction, such that the first installation rod 112 and the two first rotation rods 111 may cooperatively form a stable U-shaped or a side of a rectangular frame. The second installation rod 122 may be configured in a similar manner.

Each of the two first rotation rods 111 and a respective one of the two second rotation rods 121 may be rotatably connected to each other at a corresponding position via a hinge, a rotation shaft, a rivet, or the like. The connection point may be the pivot for the folding movement of the entire bracket. All rods may be made of metal materials or high-strength plastics, such as stainless steel, aluminum alloy, and so on. Furthermore, the first installation portion 22 may be directly sleeved (i.e., encasing or wrapping around) on the first installation rod 112, and the second installation portion 23 may be similarly sleeved on the second installation rod 122. The sleeving connection may achieve reliable connection between the body portion 21 and the foldable bracket 1 and may allow the installation portion to slide or rotate to a certain extent along the installation rod to adapt to a position change during folding.

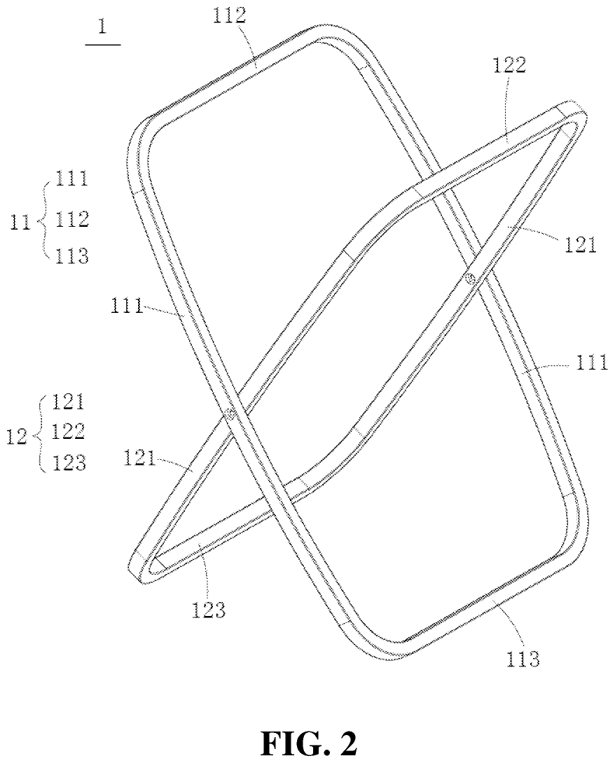

In some embodiments, as shown in FIG. 2, the two first rotation rods 111 and the first installation rod 112 may be integrally formed with each other, and the two second rotation rods 121 and the second installation rod 122 may be integrally formed with each other, such as being formed by metal bending, welding, or injection molding. In this way, the number of components may be reduced, the number of assembling operations may be reduced, and the number of connection points may be reduced, such that overall structural robustness and stability may be improved, and a production efficiency may be increased.

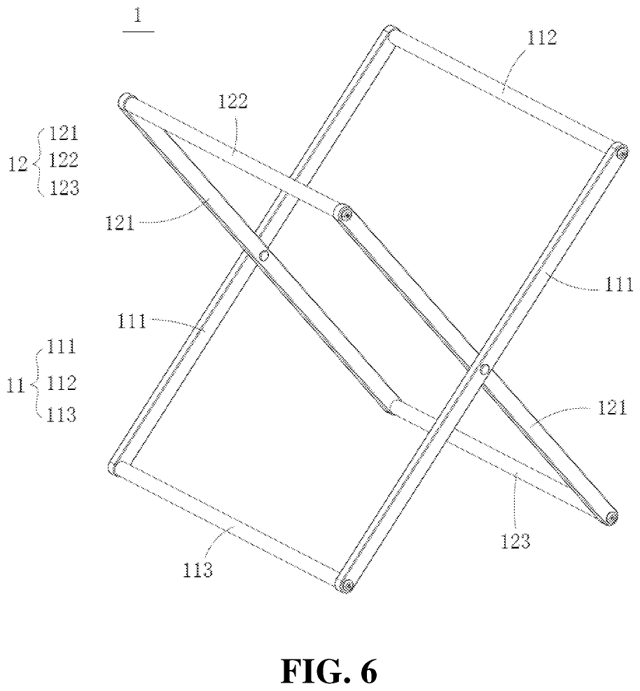

Alternatively, in some embodiments, as shown in FIG. 6, two ends of the first installation rod 112 may be respectively detachably connected to the two first rotation rods 111, and two ends of the second installation rod 122 may be respectively detachably connected to the two second rotation rods 121. Specifically, the two ends of the first installation rod 112 may be fixed to the two first rotation rods 111 via detachable means, such as threaded connection or snap-fit connection, and so on. The connection between the second installation rod 122 and the two second rotation rods 121 may be configured similarly. By configuring the detachable connection, a packaging and transportation cost of the towel heating device may be reduced, and the detachable connection may be suitable for the non-detachably arranged first installation portion 22 and second installation portion 23.

Further, the first support 11 may further include a first bearing rod 113 connected to the two first rotation rods 111. The first bearing rod 113 may be arranged opposite to the first installation rod 112. The second support 12 may further include a second bearing rod 123 connected to the two second rotation rods 121, the second bearing rod 123 may be arranged opposite to the second installation rod 122. The first bearing rod 113 and the second bearing rod 123 may abut against the ground to enlarge a contact area between the foldable bracket 1 and the ground, improving supporting stability.

It can be understood that in some embodiments, as shown in FIG. 2, the two first rotation rods 111 and the first bearing rod 113 may be integrally formed with each other, and the two second rotation rods 121 and the second bearing rod 123 may be integrally formed with each other, such as being formed by metal bending, welding, or injection molding, such that overall structural robustness and stability may be improved.

Alternatively, in some embodiments, as shown in FIG. 6, two ends of the first bearing rod 113 may be respectively detachably connected to the two first rotation rods 111, and two ends of the second bearing rod 123 may be respectively detachably connected to the two second rotation rods 121. Specifically, the two ends of the first bearing rod 113 may be fixed to the two first rotation rods 111 via detachable means, such as threaded connection or snap-fit connection. Connection between the second bearing rod 123 and the two second rotation rods 121 may be configured similarly.

In addition, when the foldable bracket 1 is unfolded, the first bearing rod 113 and the second bearing rod 123 may abut against the ground, and a bottom side of the body portion 21 may be higher than the first bearing rod 113 and the second bearing rod 123. Therefore, the body portion 21 may be suspended, preventing ground moisture from wetting the body portion 21.

The above embodiments in regard to connection of the first installation rod 112, the second installation rod 122, the first bearing rod 113, and the second bearing rod 123 may be used in any combination, and at least the following embodiments may be obtained.

In an embodiment I, as shown in FIG. 2, in the first support 11, the two first rotation rods 111, the first installation rod 112, and the first bearing rod 113 may be integrally formed with each other. In the second support 12, the two second rotation rods 121, the second installation rod 122, and the second bearing rod 123 may be integrally formed with each other. Specifically, each of the first support 11 and the second support 12 may be formed by a single steel tube being bent, so as to form a closed-loop rigid structure.

In an embodiment II, as shown in FIG. 6, in the first support 11, each of the two ends of the first installation rod 112 may be connected to one end of the respective one of the two first rotation rods 111 via a bolt. Each of the two ends of the first bearing rod 113 may be connected to the other end of the respective one of the two first rotation rods 111 via a bolt. In the second support 12, each of the two ends of the second installation rod 122 may be connected to one end of the respective one of the two second rotation rods 121 via a bolt, and each of the two ends of the second bearing rod 123 may be connected to the other end of the respective one of the two second rotation rods 121 via a bolt.

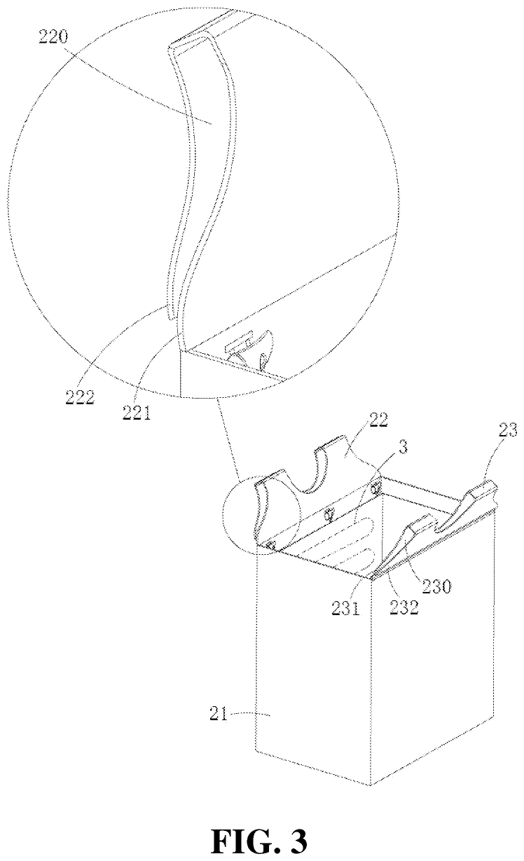

In regard to a structure of the two installation portions, in some embodiments, as shown in FIGS. 1 and 3, the first installation portion 22 may be entirely flexible. A first end 221 of the first installation portion 22 may be integrally connected to the body portion 21. The first installation portion 22 may be folded over to enable a second end 222 of the first installation portion 22 to be detachably connected to the first end 221 of the first installation portion 22 and/or the body portion 21. In this way, the first installation portion 22 itself may enclose to form a first passing space 220, and the first installation rod 112 may pass through the first passing space 220. Similarly, the second installation portion 23 may be entirely flexible. A first end 231 of the second installation portion 23 may be integrally arranged on the body portion 21. The second installation portion 23 may be folded over to enable a second end 232 of the second installation portion 23 to be detachably connected to the first end 231 of the second installation portion 23 and/or the body portion 21. In this way, the second installation portion 23 itself may enclose to form a second passing space 230, and the second installation rod 122 may pass through the second passing space 230.

In some embodiments, as shown in FIG. 3, the second end 222 of the first installation portion 22 may be detachably connected to the first end 221 of the first installation portion 22 via a hook-and-loop structure. The second end 232 of the second installation portion 23 may be detachably connected to the first end 231 of the second installation portion 23 by a hook-and-loop structure. The hook-and-loop structure may be suitable for the integrally formed first support 11 and second support 12 and suitable for the detachably configured first support 11 and second support 12.

Specifically, each of the first installation portion 22 and the second installation portion 23 may be made of flexible materials, such as fabric. The first passing space 220 may provide a guiding and wrapping path for the first installation rod 112, and the second passing space may provide a guiding and wrapping path for the second installation rod 122. In this way, a connection position may be stable, and relative sliding during folding may be allowed, such that a structural damage due to rigid connection may be avoided. The hook-and-loop structure may facilitate repetitively disassembling and assembling, allowing the folded first installation portion 22 or the folded second installation portion 23 to be quickly fixed or released. In this way, disassembling and assembling may be achieved more easily, and a certain extent of adhesion may be provided during use to prevent loosening.

In regard to a structure of the two installation portions, in some embodiments, as shown in FIGS. 5 and 7, both ends of the first installation portion 22 may be fixed to the body portion 21, such that the first installation portion 22 may enclose to form the first passing space 220, and the first installation rod 112 may pass through the first passing space 220. Both ends of the second installation portion 23 may be fixed to the body portion 21, such that the second installation portion 23 may enclose to form the second passing space 230, and the second installation rod 122 may pass through the second passing space 230.

In these embodiments, each of the first installation portion 22 and the second installation portion 23 may be made of metal and may be connected to the body portion 21 via a bolt, an adhesive, and so on. Alternatively, each of the first installation portion 22 and the second installation portion 23 may be made of flexible material and may be connected to the body portion 21 via an adhesive, sewing, and so on.

In some embodiments, as shown in FIG. 1, the body portion 21 may be formed by an outer shell 2101 and an inner liner 2102 detachably connected to an inside of the outer shell 2101. The first installation portion 22 and the second installation portion 23 may be connected to the outer shell 2101.

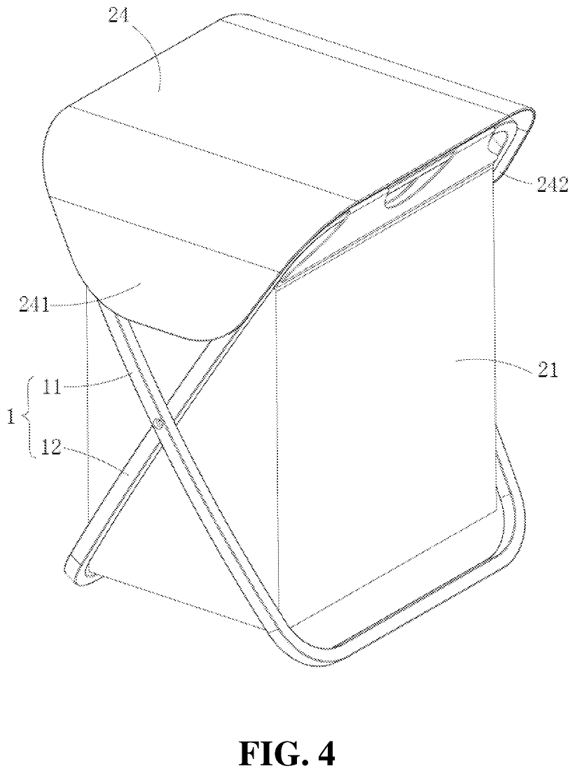

In addition, as shown in FIGS. 4, 5, and 8, the device body 2 may further include a top cover 24. A first end 241 of the top cover 24 may be detachably or fixedly connected to the body portion 21 or the foldable bracket 1. A second end 242 of the top cover 24 may be opened or closed to expose or cover an opening at a top of the body portion 21, such that the heating chamber 210 is capable of being sealed.

In some of these embodiments, as shown in FIG. 4, both the first end 241 and the second end 242 of the top cover 24 may be detachably connected to the foldable bracket 1 via magnetic attraction or a hook-and-loop structure, or in any other manner.

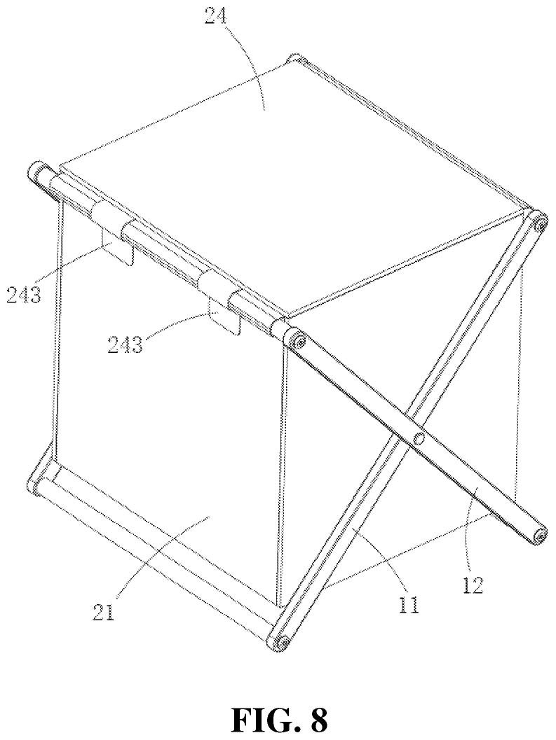

In some embodiments, the first end 241 of the top cover 24 may be sewn, integrally connected, or detachably connected to the body portion 21. The first end 241 of the top cover 24 may be adapted to the first installation portion 22, and the second end 242 of the top cover 24 may be a free end. As shown in FIGS. 5 and 8, at least one connecting portion 243 may be arranged at the first end 241 of the top cover 24. At least a part of the connecting portion 243 at a connection position with the top cover 24 may be flexible. The connecting portion 243 may be connected to the body portion 21 by bolting or sewing, or via a hook-and-loop structure.

According to the towel heating device of the present disclosure, by rotating the foldable bracket, the device body connected to the foldable bracket may be driven to be folded. In this way, a three-dimensional device body may be compressed into a flat or compact state, the occupied space thereof when the towel heating device is not in use or is being transported may be greatly reduced.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. A towel heating device, comprising:
a foldable bracket, comprising a first support and a second support rotatably connected to the first support;
a device body, comprising a body portion, a first installation portion and a second installation portion, wherein, the first installation portion and the second installation portion are formed respectively on two sides of the body portion; at least part of the body portion is flexible, and the body portion is capable of being folded or unfolded; a heating chamber is formed inside the body portion; the first installation portion is adaptively connected to the first support, the second installation portion is adaptively connected to the second support; and
a heating assembly, arranged inside the body portion and configured to heat the heating chamber;
wherein, the first support and the second support are capable of moving with respect to each other to unfold or fold the body portion.

2. The towel heating device according to claim 1, wherein:
the first support comprises two first rotation rods opposite to each other and a first installation rod connected to the two first rotation rods; the first installation portion is sleeved on the first installation rod; and
the second support comprises two second rotation rods that are opposite to each other and a second installation rod connected to the two second rotation rods; each of the two second rotation rods is rotatably connected to a respective one of the two first rotation rods; the second installation portion is sleeved on the second installation rod.

3. The towel heating device according to claim 2, wherein, the two first rotation rods and the first installation rod are integrally formed with each other, and the two second rotation rods and the second installation rod are integrally formed with each other.

4. The towel heating device according to claim 2, wherein, two ends of the first installation rod are respectively detachably connected to the two first rotation rods, and two ends of the second installation rod are respectively detachably connected to the two second rotation rods.

5. The towel heating device according to claim 2, wherein, the first support further comprises a first bearing rod connected to the two first rotation rods, the first bearing rod is disposed opposite to the first installation rod; the second support further comprises a second bearing rod connected to the two second rotation rods, the second bearing rod is disposed opposite to the second installation rod.

6. The towel heating device according to claim 5, wherein, the two first rotation rods and the first bearing rod are integrally formed with each other, and the two second rotation rods and the second bearing rod are integrally formed with each other.

7. The towel heating device according to claim 5, wherein, two ends of the first bearing rod are respectively detachably connected to the two first rotation rods, and two ends of the second bearing rod are respectively detachably connected to the two second rotation rods.

8. The towel heating device according to claim 1, wherein:
the first installation portion is flexible, a first end of the first installation portion is integrally arranged with the body portion, the first installation portion is folded to enable a second end of the first installation portion to be detachably connected to the first end of the first installation portion and/or the body portion; the first installation portion forms a first passing space, and the first installation rod passes through the first passing space; and
the second installation portion is flexible, a first end of the second installation portion is integrally arranged with the body portion, the second installation portion is folded to enable a second end of the second installation portion to be detachably connected to the first end of the second installation portion and/or the body portion; the second installation portion forms a second passing space, the second installation rod passes through the second passing space.

9. The towel heating device according to claim 8, wherein, the second end of the first installation portion is detachably connected to the first end of the first installation portion and/or the body portion via a hook-and-loop structure; and the second end of the second installation portion is detachably connected to the first end of the second installation portion and/or the body portion via a hook-and-loop structure.

10. The towel heating device according to claim 1, wherein:
two ends of the first installation portion are both fixed to the body portion, the first installation portion encloses to form a first passing space, and the first installation rod passes through the first passing space; and
two ends of the second installation portion are both fixed to the body portion, the second installation portion encloses to form a second passing space, and the second installation rod passes through the second passing space.

11. The towel heating device according to claim 1, wherein, the entire body portion is flexible.

12. The towel heating device according to claim 1, wherein, the body portion comprises at least two rigid parts and a flexible part connected to the two rigid parts, and the two rigid parts is capable of moving toward or away from each other.

13. The towel heating device according to claim 5, wherein, a bottom side of the body portion is higher than the first bearing rod and the second bearing rod.
